(19) United States
(12) Patent Application Publication
(10) Pub. No.: US 2006/0123677 A1
(43) Pub. Date: Jun. 15, 2006

(54) Container and method for making same

(76) Inventor: Anton Jazbinsek, Tettnang (DE)

Correspondence Address: Pandiscio & Pandiscio, 470 Totten Pond Road, Waltham, MA, 02451, US

(21) Appl. No.: 11/254,305

(22) Filed: Oct. 20, 2005

(30) Foreign Application Priority Data
Oct. 23, 2004 (DE) 102004051681.2-27

(51) Int. Cl. G09F 3/00

(52) U.S. Cl. 40/310

(57) ABSTRACT

A container of a thermally formable plastic, an outer surface of the container being at least in part covered by a label which is bonded to the container during the process of forming the container.

### BACKGROUND OF THE INVENTION

1. Field of the Invention

The present invention relates to a container made from a thermally formable plastic, an outer jacket surface of which is wholly or partially covered by a label, e.g., a printed publicity carrier, as well as to a process for manufacturing such a container.

2. Description of the Prior Art

Containers for holding paste-like, liquid, or pourable goods in a large number of different designs, in particular as yoghurt pots, sweet packagings, and beverage bottles, are familiar from prior art. The outer jacket surfaces of these containers are configured as publicity carriers in order to bring the contents of the container to the attention of a wide public.

Printing on the outer jacket surface of the containers is only possible with very considerable expense, therefore labels are provided as publicity carriers onto which printed motifs can be applied in a straightforward manner and which can be attached to the containers. In this case, the labels consist of a plastic foil and, after printing, are subsequently attached to the outer jacket surface of the container by shrinking or gluing.

In this way, it is possible to produce very high quality packaging containers. However, it is extremely costly to dispose of them after the goods they contain have been consumed. Although the containers with their lid and publicity carrier are entirely composed of plastic and can be incinerated or recycled by crushing, the charges imposed by the state for this are disproportionate in relation to the manufacturing costs with the result that the goods stored in containers of this type are rendered significantly more expensive.

### SUMMARY OF THE INVENTION

The objective of the present invention is therefore to provide a container for holding goods and which can be used in the same way as the containers of prior art, but for which no or only small charges are payable to the state, with the result that the proportion of external costs is low and the container can be disposed of without entailing great cost. There is further provided a method for manufacturing the container without difficulty, in an economical fashion, and for use in a wide number of ways.

In accordance with the present invention, this is achieved in a container of the aforementioned type in that the label is manufactured from a material containing cellulose, in particular paper, in that the label is connected to the container with a wire side facing the container, by melting the outer jacket surface of the container during its forming, and in that the label is printed on a felt side.

In this case, the label can easily be integrated into a recess formed into the outer jacket surface of the container and extending, in a preferred embodiment, around the circumference of the container, in which case the recess should be indented into the outer jacket surface of the container by the thickness of the material of the label.

The process for manufacturing a container of this type is characterised in that in a container manufactured by injection moulding, blowing or deep drawing, the label is placed in the mould in the area where the label is to be attached before the container is moulded and the label is firmly connected to the container due to the melting of the outer jacket surface of the container during its forming. The forming of the container can take place at a temperature of around 270° C. in this case.

If, in a container consisting of a thermally formable plastic, the label provided on its outer jacket surface as a publicity carrier is manufactured from paper then not only are the manufacturing costs of the container reduced in comparison to the containers used in the past because a paper label can be produced significantly more cheaply than a label made from plastic foil, but also it is cheaper to dispose of the container. Containers with a paper label are namely classified as mixed products and attract only a fraction of the disposal charges that are applied to completely plastic products.

For almost the same inherent weight, the same durability and without any restrictions on its use, the container configured in accordance with the present invention therefore offers significant economical advantages.

### BRIEF DESCRIPTION OF THE DRAWINGS

The drawings show sample embodiments of a thermally formable container provided with a paper label, and its various manufacturing processes, which are subsequently explained in detail. In the drawings,

FIG. 1 shows a view of the container with a label made from paper,

FIG. 2 shows a developed view of the label used on the container shown in FIG. 1,

FIG. 3 shows a section through the line III-III in FIG. 2, in a magnified view,

FIG. 4 shows a partial section of the container shown in FIG. 1 with a label inserted,

FIG. 5 shows the container shown in FIG. 1 during its manufacture in an injection mould,

FIG. 6 shows an exploded view of the container removed from the mould shown in FIG. 5,

FIG. 7 shows a mould for manufacturing the container shown in FIG. 1 by means of blowing and

FIG. 8 shows a mould for manufacturing the container shown in FIG. 1 by means of deep drawing.

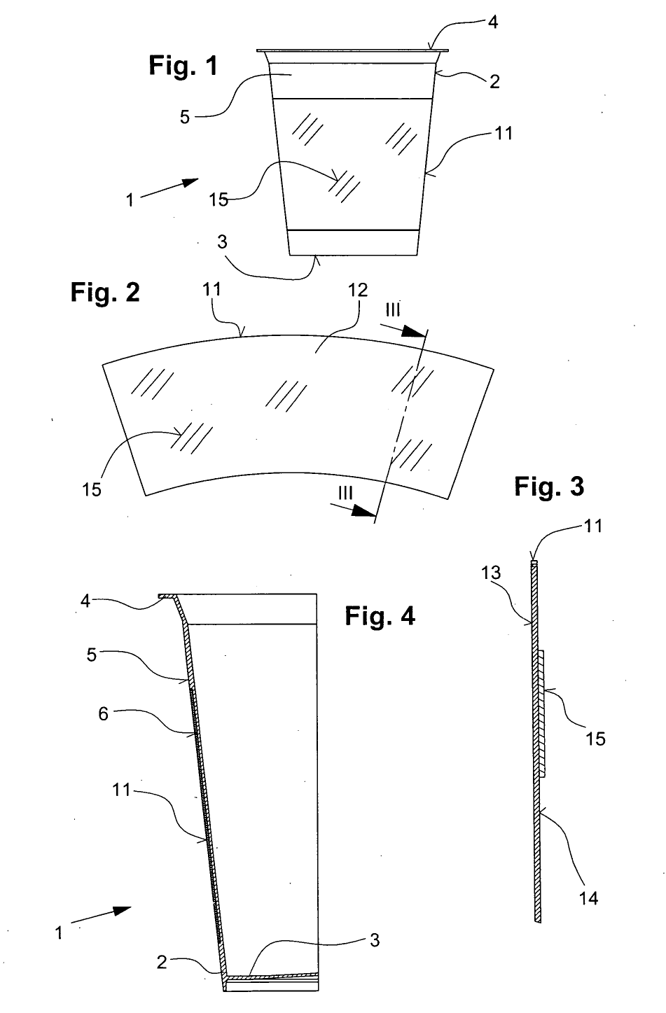

The container identified with 1 in FIGS. 1, 4 and 6 is shaped in the form of a pot and is used for holding paste-like, liquid or pourable goods. In this case, a base 3 as well as a shaped part as a sealing edge 4 are formed onto a jacket 2 of the container 1, with the sealing edge 4 serving to attach a sealing lid that is not illustrated. In order to inform customers in particular about the contents of the container 1, a label 11 is attached to the outer jacket surface 5 of the jacket 2, the label 11 being configured as a publicity carrier and provided with printed motifs 15 on the outside.

The label 11 is manufactured from a material containing cellulose, e.g., a thin paper, that, as shown in FIGS. 2 and 3, is configured as a section of a ring 12. The wire side 13 of the label 11 is in contact with the outer jacket surface 5 of the jacket 2, whereas printed motifs 15, such as images or texts, are printed on the felt side 14 of the label. As shown in FIG. 3, the label 11 can also be arranged in a recess 6 in the jacket 2 of the container 1.

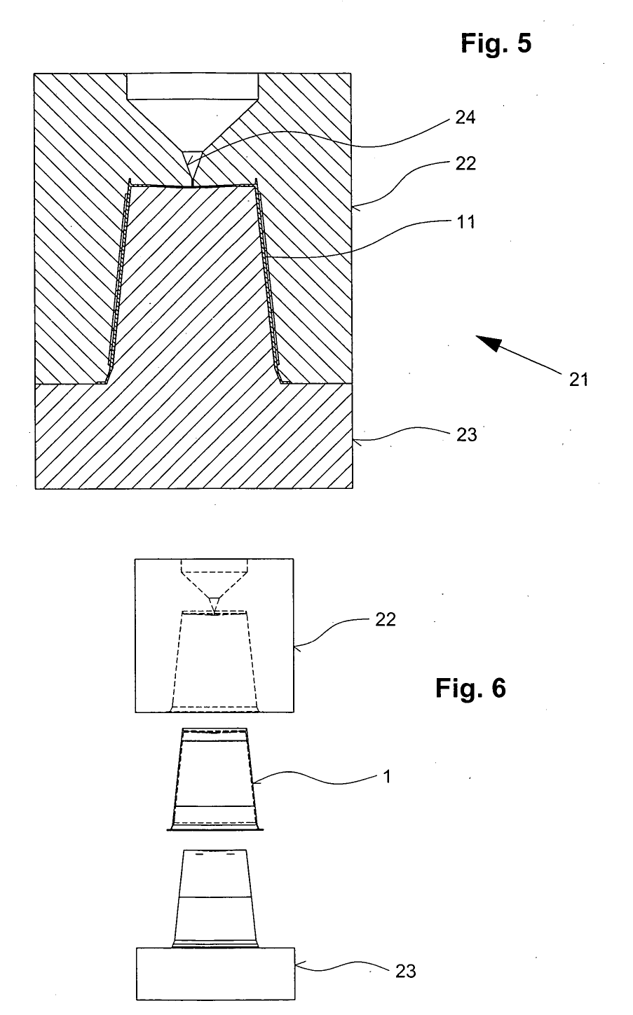

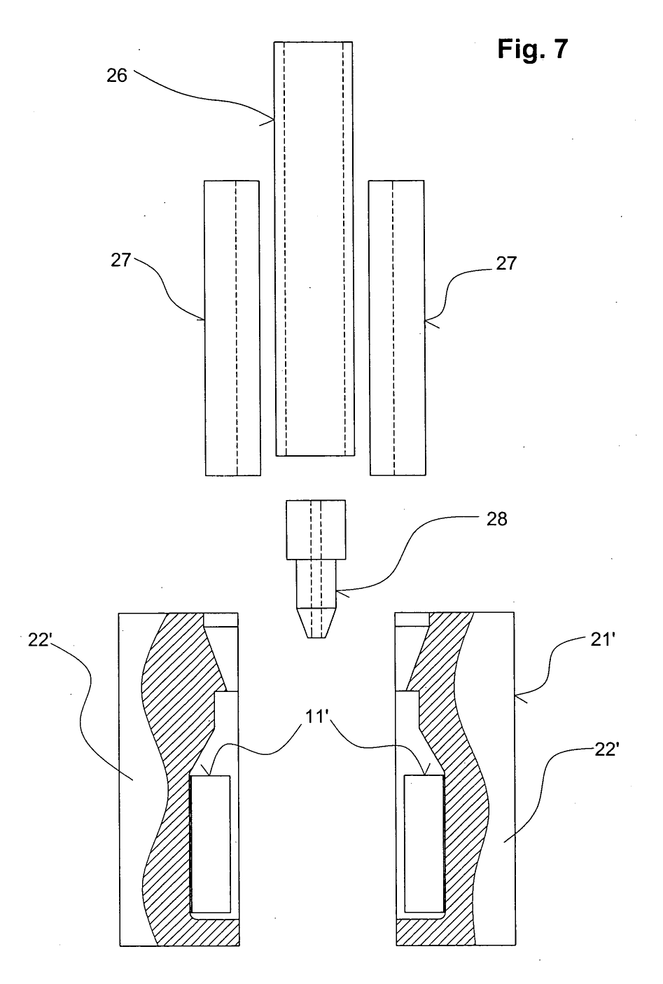

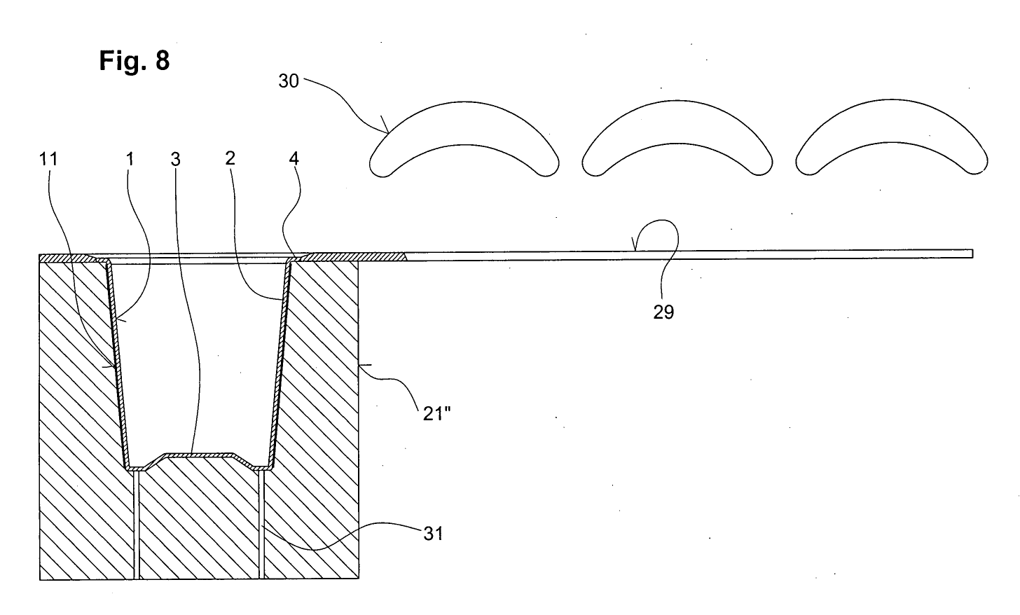

The container 1 can be manufactured by an injection moulding process (FIGS. 5 and 6), by blowing (FIG. 7), or by deep drawing (FIG. 8). In this case, the label 11 (FIGS. 5 and 8) or two label parts 11′ (FIG. 7) is or are inserted into a forming mould 21, 21′ or 21″ before the container 1 is formed, so that when the plastic forms the container 1, the label 11 or 11′ is firmly connected to the jacket 2 by being melted onto the outer jacket surface 5 of the jacket 2.

As shown in FIG. 5, the forming mould 21 consists of a die 22 and a punch 23 between which there is a cavity in order to form the container 1. The molten plastic is inserted into the forming mould 21 through a nozzle 24 at a temperature of about 270° C. with the label 11 made from paper in contact with the die 22 of the forming mould 21, with the effect that the label 11 is firmly connected to the container 1 when the container 1 is formed.

As illustrated in FIG. 7, a container not shown in the Figure is formed by inflating a hose 26 that is heated by heating elements 27 before being inserted into the forming mould 21′ formed by two forming die jaws 22′. The two-piece label 11′ lies in the forming jaws 22′ and bonds to the outer jacket surface of the hose 26 as soon as this is brought into contact with the forming jaws 22′ by compressed air admitted via a nozzle 28.

Also in the process shown in FIG. 8, the label 11 is inserted into the forming mould 21″ and is connected to the outer jacket surface 5 as soon as the container 1 is formed by evacuating the forming mould 21″ by extracting the air through holes 31. The plastic material is supplied to the forming mould 21″ as a plate 29 for this purpose and is heated by radiant heaters 30 in order to permit the forming to take place.

The label 11 made from paper is firmly connected to the container 1 in each case by the melting of the surface of the jacket 2 at a temperature of about 270 ° C.

1. A container (1) made from a thermally formable plastic, an outer jacket surface (5) of which is at least partially covered by a label (11) in the form of a printed publicity carrier,
wherein the label (11) is manufactured from paper, the label (11) is connected to the container (1) with a wire side (13) thereof facing the container (1) by melting the outer jacket surface (5) of the container (1) during its forming, and the label (11) is printed on a felt side (14) thereof.

2. The container in accordance with claim 1,
wherein the label (11) is integrated into a recess (6) formed into the outer jacket surface (5) of the container (1) and extends around the circumference of the container (1).

3. The container in accordance with claim 2,
wherein the recess (6) in the container (1) is indented into the outer jacket surface (5) of the container (1) by the thickness of the material of the label (11).

4. (canceled)

5. A method for manufacturing a container having a label thereon, the method comprising the steps of:
placing the label in a mold in an area where the label is to be attached to a jacket portion of the container; and
molding the container by a selected one of injection molding, blow molding, and deep drawing;
whereby the label is fixed to the molten container jacket portion during the forming of the container.

6. The method in accordance with claim 5 wherein the molding of the container is effected at a temperature of about 270° C.
